(19) United States
(12) Patent Application Publication
(10) Pub. No.: US 2017/0264664 A1
(43) Pub. Date: Sep. 14, 2017

(54) MODERATING APPLICATION COMMUNICATIONS ACCORDING TO NETWORK CONDITIONS

(71) Applicant: Microsoft Technology Licensing, LLC, Redmond, WA (US)

(72) Inventors: Brian Schwartz, Bellevue, WA (US); Marcelo De Barros, Redmond, WA (US); Ansuman Kar, Redmond, WA (US)

(21) Appl. No.: 15/178,500

(22) Filed: Jun. 9, 2016

Related U.S. Application Data
(60) Provisional application No. 62/305,934, filed on Mar. 9, 2016.

(51) Int. Cl. H04L 29/06; H04L 12/26

(52) U.S. Cl. CPC H04L 65/80; H04L 43/08

(57) ABSTRACT

Systems, methods and computer-readable media are presented for moderating the network connectivity of an application according to network connectivity quality. A monitoring component and/or process receives information regarding network requests from the computing device, filters the requests according to an application, and for each of the filtered network requests generates a network request tuple from the network request and stores the information in a communication queue. A moderating component and/or process receives a network request of the application, evaluates the network connectivity quality for the application according to the information in the communication queue, and moderates the network request activity of the application commensurate with the network connectivity quality.

### BACKGROUND

When a computer user loads an app or application onto a computing device, there is an expectation of responsiveness: that the app/application will respond quickly in performing its various functions. However, when the app or application fails to be responsive, it is not necessarily the fault of app but, rather, a product of connectivity issues, especially for those apps or applications that rely on communicating with external (to the computing device) services, resources, computers, etc.

Further, connectivity issues aren't necessarily caused simply by poor or weak connections to a network. Indeed, even when a quality, high bandwidth connection to a network is established, connectivity issues may arise because a particular service or resource is congested or is, itself, experiencing connectivity issues.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Systems, methods and computer-readable media are presented for moderating the network connectivity of an application according to network connectivity quality. A monitoring component and/or process receives information regarding network requests from the computing device, filters the requests according to an application, and for each of the filtered network requests generates a network request tuple from the network request and stores the information in a communication queue. A moderating component and/or process receives a network request of the application, evaluates the network connectivity quality for the application according to the information in the communication queue, and moderates the network request activity of the application commensurate with the network connectivity quality.

According to various aspects of the disclosed subject matter, a method for moderating the network connectivity of an application with regard to network connectivity quality is presented. The method includes maintaining a communication queue of most recent network request data of a moderated application on a computing device. Additionally, a current network connectivity quality is determined for the moderated application according to the network request data of the moderated application maintained in the communication queue. Further, a moderation instruction is issued to the moderated application corresponding to the determined current network connectivity quality for the moderated application. The moderation instruction corresponds to a directive to the moderated application to alter network request activity from a first level of functionality to a second level of functionality.

According to further aspects of the disclosed subject matter, a computer-readable medium bearing computer-executable instructions. The instructions, when executed by a processor of a computing device, carry out a method for moderating the network connectivity of a moderated application with regard to network connectivity quality. The method comprises maintaining a communication queue of most recent network request data of the moderated application on a computing device. The most recent network request data in the communication queue includes network request tuples, where each network request tuple corresponds to a recent network request of the moderated application. Additionally, a current network connectivity quality is determined for the moderated application according to the communication queue and a moderation instruction is issued to the moderated application, the moderation instruction corresponding to the determined current network connectivity quality for the moderated application. More particularly, the moderation instruction corresponds to a directive to the moderated application to alter network request activity from a first level of functionality to a second level of functionality.

According to still further aspects of the disclosed subject matter, a computing device configured to moderate the network connectivity of a moderated application with regard to network connectivity quality is presented. The computing device comprising a processor and a memory, wherein the processor executes instructions stored in the memory. In execution, the processor causes the computing device to maintain a communication queue of most recent network request data of the moderated application. Further, a current network connectivity quality is determined for the moderated application according to the most recent network request data of the moderated application in the communication queue. Based on the determined current network connectivity quality, a moderation instruction is issued to the moderated application. The moderation instruction corresponds to a directive to the moderated application to alter its network request activity from a first level of functionality to a second level of functionality.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a pictorial diagram illustrating an exemplary network environment suitable for implementing aspects of the disclosed subject matter;

FIG. 2 is a block diagram illustrating an exemplary inter-operation of components configured to moderate network communications activity of an app, according to aspects of the disclosed subject matter;

FIG. 3 is a flow diagram illustrating an exemplary routine for monitoring current network conditions in accordance with aspects of the disclosed subject matter;

FIG. 4 is a flow diagram illustrating an exemplary routine for moderating network communications according to current network conditions according to aspects of the disclosed subject matter;

FIG. 5 is a flow diagram illustrating an exemplary routine for resetting a communication queue upon detection of a change in the network channel by which the computing device communicates with external services, resources and devices on a network;

FIG. 6 is a flow diagram illustrating an exemplary routine 600 as implemented by an application configured to moderation network communication requests according to network quality;

FIG. 7 is a block diagram illustrating an exemplary computer readable medium encoded with instructions for moderating network communications of an application according to current network conditions in accordance with aspects of the disclosed subject matter;

FIG. 8 is block diagram illustrating an exemplary computing device suitably configured to moderate network communications of an application according to network conditions in in accordance with aspects of the disclosed subject matter; and

FIG. 9 is a block diagram illustrating an alternative exemplary computing device suitably configured to moderate network communications of an application according to network conditions in in accordance with aspects of the disclosed subject matter.

### DETAILED DESCRIPTION

For purposed of clarity, the use of the term “exemplary” in this document should be interpreted as serving as an illustration or example of something, and it should not be interpreted as an ideal and/or leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users.

For purposed of this document, the term “application” should be interpreted as a computer program comprised of computer-executable code designed to perform a group of coordinated functions, tasks, or activities for the benefit of the user of the computer or computing device. The term “app” should also be interpreted as a computer program comprised of computer-executable code designed to perform a group of coordinated functions, tasks, or activities for the benefit of the user of the computer or computing device. Generally speaking, the distinction between an app and an application lies in the complexity of design and/or size, where an app is typically smaller in size than an application and focused on a single function or a small set of related functionality. In contrast, an application is typically more robust, covering a broader spectrum of functionality which also implies greater size. Due to their natures, apps are typically used on computing devices of more limited processing abilities, whereas applications are typically used on computing devices that have more processing capabilities. Irrespective of the differences (or lack thereof) between an app and an application, aspects of the disclosed subject matter may be suitably implemented within either an app or application, or be suitably implemented on a computing device having significant processing and resource capacity or on computing devices having limited processing abilities. Accordingly, unless explicitly differentiated as being applied only to an app or only to an application, the terms app and application should be viewed as generally interchangeable for purposes of this disclosure.

In order to improve the apparent responsiveness of an app (or application), a moderation module is utilized to determine current network connectivity quality for the app and moderate the app's connectivity requests accordingly. According to aspects of the disclosed subject matter, a suitably configured app (or application) provides functionality corresponding to one or more actions that may be taken by the app to moderate (increase or decrease) its level of communication activity commensurate with the current network connectivity quality.

In particular, a communications queue is maintained for the app. The communication queue includes communication information regarding the most recent communications of the app over the network. The communication information includes, by way of illustration and not limitation, the time to complete a network request (from the initiation of the request to receipt of the final communication packet), the amount of data sent and/or received with regard to a network request, and/or whether or not the network request resulted in a failure (i.e., failed to complete). Further still and according to additional embodiments, the communication queue is a circular queue in which only the n most recent network requests from the app are maintained (where n corresponds to some predetermined number, such as, by way of illustration and not limitation, 30 as in 30 network requests).

To facilitate and maintain the most recent communication information of the app in the communication queue, a network request monitor receives network requests of the computing device and filters the requests according to those corresponding to the particular app. A storage module takes each of the filtered network requests (i.e., those that remain after the filtering for the app) in chronological order, extracts the communication information from the network request that is to be stored in the communication queue, and enters the extracted communication information for the network request into the communication queue, cycling through the communication queue in a circular manner such that only the communication information of the n most recent network requests is maintained within the queue.

Additionally and according to various aspects of the disclosed subject matter, the entries in the communications queue correspond to a single communication channel. Accordingly, when the computing device switches communications channels (e.g., switches from a 3G communications channel (e.g., 4G via CDMA) to a WiFi communication channel (e.g., 802.11x)), the communication queue is emptied and new communication information is entered as network requests from the app are detected. In this manner, the communication monitoring module can moderate network activity according to current communication channel conditions, not based on previous conditions that may no longer be applicable.

As mentioned above, moderation module is utilized to determine current network connectivity quality for the app and moderate the app's connectivity requests accordingly. The determination of network connectivity quality is made according to internal heuristics, thresholds, and the communication information stored in the communications queue. By way of illustration and not limitation, the heuristics may include factoring in the number of failures, the average throughput of data including to and from communications, the number of retries (typically expressed in packets) that must be made to complete a communication, and the like. As further indicted above, based on a determination of the network connectivity quality, a moderation module may initiate various actions to occur with an app or application such that the amount of network requests generated by the app/application is moderated according to the network connectivity quality.

While this determination of communication quality may be binary, i.e., quality sufficient for full-featured vs. reduced-featured operation, in many instances the determination may produce a quality rating of more than just two values. By way of illustration and not limitation, a determination of communication quality may return one of three levels of quality (corresponding to full-, middle-, reduced-featured operation), or according to a percentage value (i.e., a value between a highest quality value and a lowest quality value, e.g., 100 and 0, where zero (0) indicates the poorest/lowest quality value of communication quality.) Of course, while the moderation module may be able to moderate communication activity of an app according to a variety of communication quality values, of equal importance is the ability of the app to provide for different levels of operation. According to one embodiment, the app implements or provides functionality for moderating communication activity according to the determined communication quality, e.g., binary functionality (high/low), tertiary functionality (high/medium/low), percentage value, etc. Moderating network request activity may be implemented through, by way of illustration and not limitation, reduced network request calls, requesting compressed, smaller and/or reduced quality images or data, suspending pre-fetch requests, aggregate network requests for few submissions, and the like. Further, supportive but not mandatorily, network requests may be disabled according to the network connectivity quality currently detected.

In implementing the actions to moderate network requests according to network connectivity quality, a suitably configured app may implement a callback function that a moderation module calls in regard to network connectivity quality. Alternatively, the moderation module may be configured, as part of the app, to make various changes to accommodate the network connectivity quality, or by way of predetermined application programming interfaces (APIs) implemented by the app/application.

According to aspects of the disclosed subject matter, the moderation module may be implemented as a computer service external to the app. In this configuration, the app would typically register with the intervention module and provide a callback function or by APIs (as discussed above) by which the moderation module can moderate the network activity of the app. Indeed, the moderation module may be implemented as part of an operating system, i.e., as an operating system service, or as a service or daemon implemented by a third party external to the app. According to aspects of the disclosed subject matter, when implemented as a module operating independent of an app, the moderation module maintains a communications queue for each app/application that utilizes the service of the moderation module.

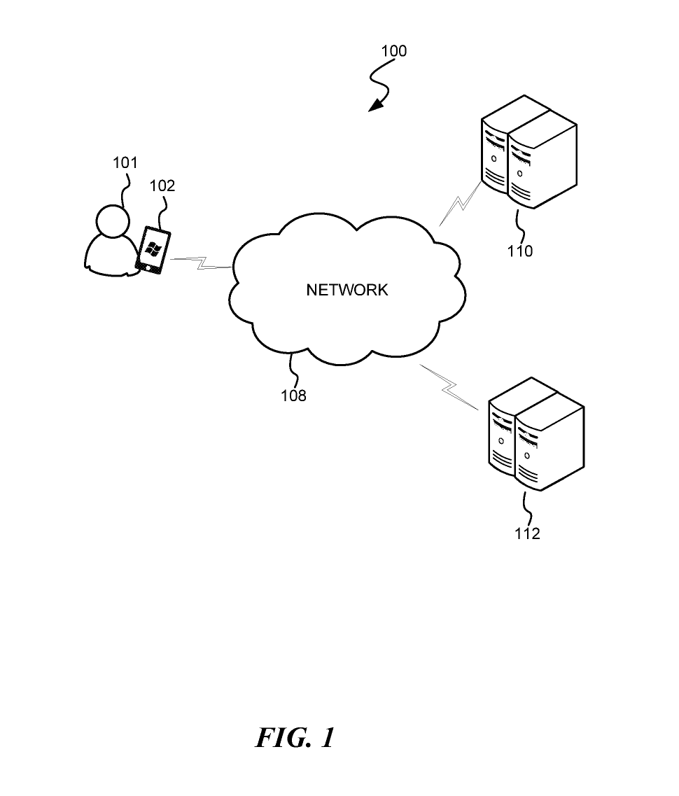

Turning now to FIG. 1, FIG. 1 is a pictorial diagram illustrating an exemplary network environment 100 suitable for implementing aspects of the disclosed subject matter. The network environment 100 includes a computer user 101 communicating over a network 108 using a computing device 102. According to aspects of the disclosed subject matter, communication with the network may be made via a wired or wireless connection. According to additional aspects of the disclosed subject matter, an app executing on the computing device may communicate (by way of network requests) with one or more other services and/or resources connected to the network, such as network computers 110 and 112. Further still, in order to moderate network activity of the computing device 102 to correspond to the current network connectivity quality, the computing device includes or accesses the functionality of a moderation module and a network request monitor as will be described in greater detail below. As already suggested, the moderation module and the network request monitor may be implemented as part of an app, as a system service on the computing device including an operating system service or third-party service, or a combination of the above.

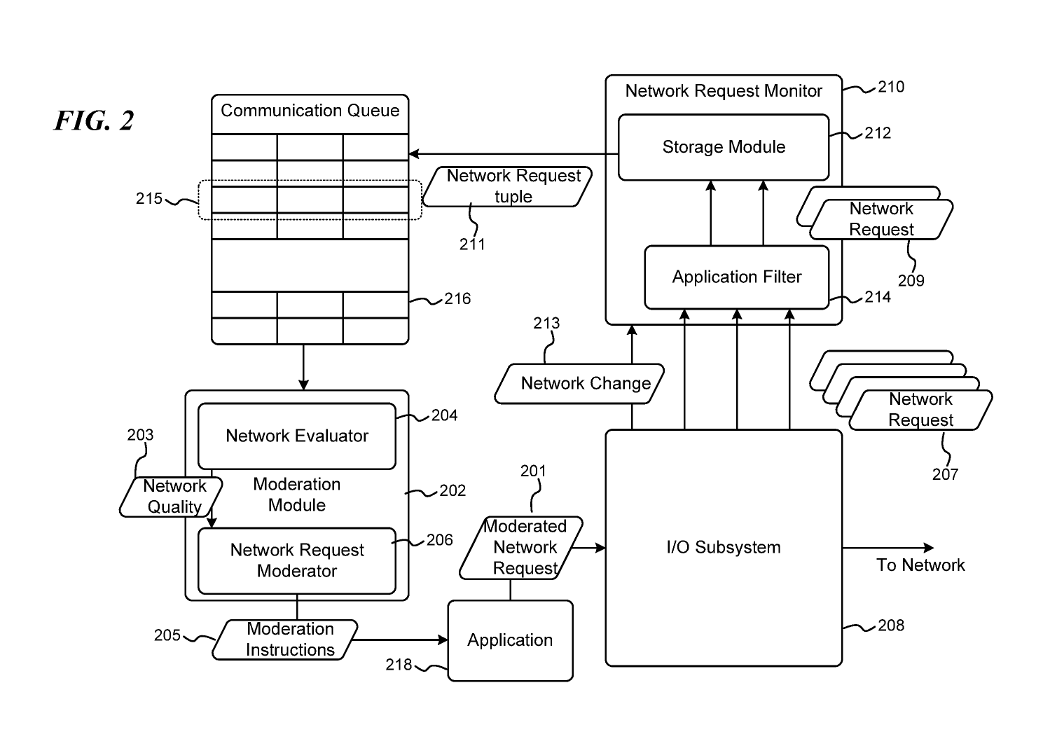

Turning to FIG. 2, FIG. 2 is a block diagram illustrating an exemplary inter-operation of components configured to moderate network communications activity of an app, according to network conditions according to aspects of the disclosed subject matter. A moderation module 202 network request data as stored in a communications queue, such as communication queue 216, where the communication queue includes network request tuples, such as network request tuple 215, that reflect the communication quality of a network request from a corresponding application, such as application 218. As shown in FIG. 2, a network request moderator 206 receives the communication queue to determine the current network connectivity quality of the current network communication channel of the corresponding application.

The network request tuples are used to determine a current network quality 203 by way of a network evaluator 204 component/function of the moderation module 202. According to the network quality information 203, the network request moderator 206 communicates with the application 218, by way of one or more moderation instructions 205, to moderate the network connectivity of the application according to the determined current network connectivity quality 203.

Based on the moderation instructions 205 issued to the application 218, at the point that the application needs to issue a network request over a network, the application issues a moderated network request 205 via the I/O subsystem of the operating system which, in turn, is communicated over the network 108 along with other network requests, such as network request 207. In short, due to the instructions received from the moderation module 202, the application moderates its network activity according to the current network connectivity quality 203.

According to one embodiment of the disclosed subject matter, the network request monitor 210 monitors elements of the computer system, such as the I/O subsystem of the operating system, and receives network request information, including all network requests 207 of the computing device. Of course, these network requests include any moderated network requests such as moderated network request 205 from application 218. Alternatively, the network request monitor 210 may be configured to detect/receive only those network requests that correspond to the app (in which case a filtering—as described below—may or may not be necessary.) In addition to network requests, the network request monitor also receives network change data 213 corresponding to a change in communication channel of the computing device to the network 108. By way of example and not limitation, a network change may occur when a device switches from communicating over a mobile data channel (such as 4G data of a mobile device) to a WiFi or wired network. Because the different network channels may provide differing network qualities, a network change is in order.

The network request monitor 210 includes an application filter 214 that filters the network requests 207 according to a corresponding app or application, such as application 218. In the event that the network request monitor is part of an app or application, the application filter 214 produces a set of filtered network requests 209 corresponding only to that app/application. Alternatively, the application filter would filter the network requests 207 according to app/application producing filtered network requests 209 for each of the apps that subscribe to the network request monitor service. A storage module 212 receives the filtered network requests 209 and processes them in chronological order. Processing includes extracting communication information from each network request and generating a network request tuple 211 that includes information that is used to evaluate network connectivity quality. Each network request tuple corresponds to a single network request and is stored in the communication queue corresponding to the app/application that issues the network request, potentially overwriting an older network request tuple already stored in the communication queue 216.

As can be seen, the overall flow of information is a continuous cycle of evaluating network connectivity quality according to a communication queue, moderating network request activity of the application according to the network connectivity quality, capturing network requests of the app and updating the communication queue with the latest information (network request tuples) such that the current network communication quality is determinable.

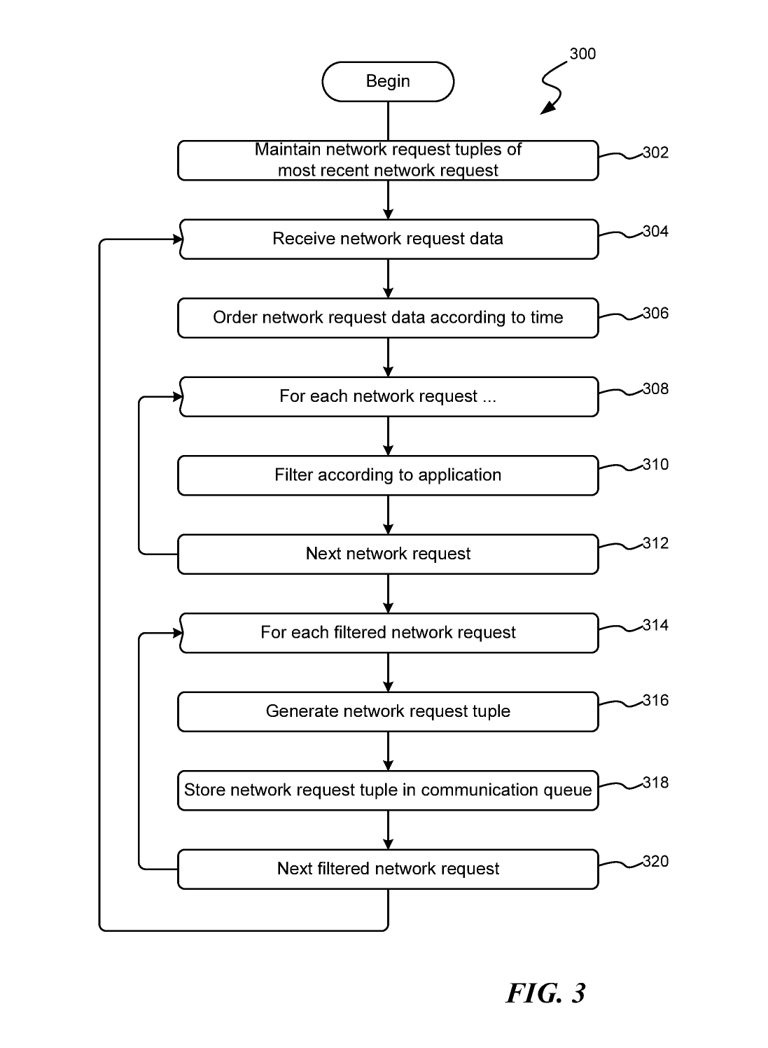

Turning to FIG. 3, FIG. 3 is a flow diagram illustrating an exemplary routine 300 for monitoring current network conditions in accordance with aspects of the disclosed subject matter. For illustration purposes, routine 300 is described in regard to processing data for a single app/application. However, it should be appreciated that the functionality represented in routine 300 is generally applicable to those situations in which a network request monitor is providing services for a plurality of apps and/or applications. Beginning at block 302, a communication queue, such as communication queue 216, is maintained for a corresponding application, such as application 218.

At block 304, network request data, such as network requests 207 of FIG. 2, is received. At block 306, if necessary, the network requests of the network request data are ordered chronologically. According to various embodiments, the network requests are ordered chronologically in order to ensure that the network communication quality assessment accurately reflects current conditions. At block 308, an iteration is begun to iterate through each of the network requests. As part of this iteration, at block 310 the network request is filtered according to app/application, such that the network request is not discarded for this app if it is part of the app's network communications. At block 312, the next network request is selected and the routine 300 returns to block 308. Alternatively, if there are no more network requests to process, the routine 300 proceeds to block 314.

At block 314, a second iteration is begun with regard to the filtered network requests 209. As part of the iteration, at block 316 the currently iterated filtered network request is processed to generate a network request tuple 211. At block 318, the generated network request tuple is stored in the communication queue, either in an open space or overwriting the oldest network request tuple in the queue. Thereafter, at block 320, the next filtered network request is selected and the routine 300 returns to block 312. Alternative, if there are no more filtered network requests to process, the routine 300 returns to block 304 to obtain new network requests and continue the monitoring process described above.

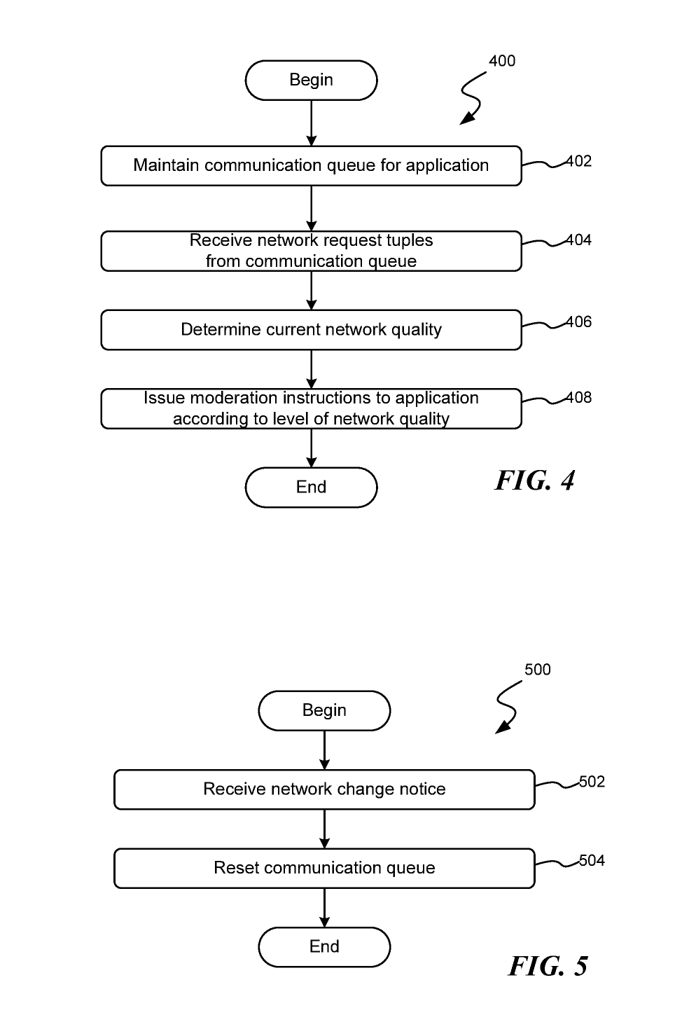

FIG. 4 is a flow diagram illustrating an exemplary routine 400 for moderating network communications according to current network communication quality, as discussed above. Beginning at block 402, network request data, often in the form of network request tuples, corresponding recent network requests of an app/application, such as application 218, are maintained a communication queue 216 for the corresponding application. At block 404, the network request tuples corresponding to the application are obtained from the communication queue. At block 406, the current network quality 203 is determined in regard to the current network conditions for the application. According to aspects of the disclose subject matter, this determination is made according to the obtained network request tuples in the communication queue 216. This determination may be made according to heuristics factoring in the number of communication failures, the average throughput of data for the communications, the number of retries (typically expressed in packets) that must be made to complete a communication, and the like. At block 408, moderation instructions are issued (via communications with the corresponding application 218) to moderate network request activity/functionality of the corresponding application 218 according to the determined network connectivity quality. As will be appreciated, the moderation instruction provides an instruction to the application to modify the network activity functionality from a first level to a second level, assuming that there is a change to the current network activity functionality of the application. Of course, the modification to the functionality may be an increase or decrease to the network activity functionality. Thereafter, routine 400 terminates.

FIG. 5 is a flow diagram illustrating an exemplary routine 500 for resetting a communication queue upon detection of a network change in the network channel by which the computing device communicates with external services, resources and devices on a network. Beginning at block 502, a network change notice 213 is received. At block 504, the communication queue 216 is reset. Resetting the communication queue comprises deleting the communication tuples of the queue (or resetting values such that the communication queue does not register as having any communication tuples.) Thereafter, the routine 500 terminates.

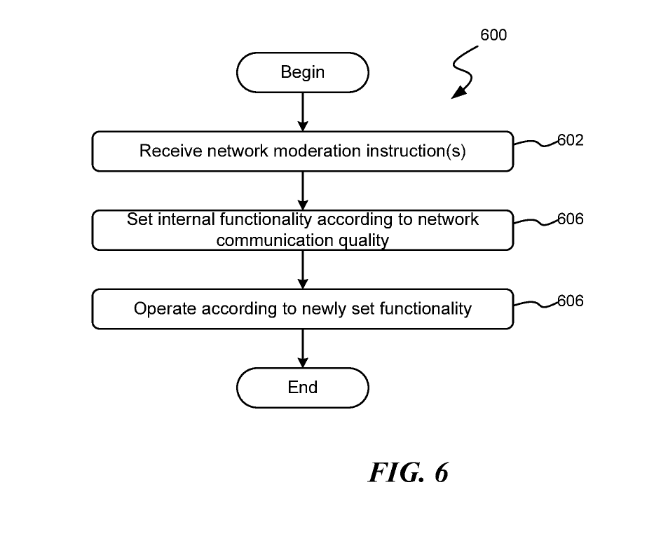

FIG. 6 is a flow diagram illustrating an exemplary routine 600 as implemented by an application configured to moderation network communication requests according to network quality. Beginning at block 602, the application (such as application 128) receives one or more network moderation instructions, such as moderation instructions 205, that indicate a current level of functionality as determined by the current network quality of the application/computing device. At block 604, the application sets internal functionality according to the current network quality as determined by the received moderation instructions. At block 606, the application then operates according to the newly set functionality with regard to network requests. Thereafter, routine 600 terminates.

Regarding routines 300-600 described above, as well as other processes describe herein (such as the process described in regard to FIG. 2), while these routines/processes are expressed in regard to discrete steps, these steps should be viewed as being logical in nature and may or may not correspond to any specific actual and/or discrete steps of a given implementation. Also, the order in which these steps are presented in the various routines and processes, unless otherwise indicated, should not be construed as the only order in which the steps may be carried out. Moreover, in some instances, some of these steps may be omitted. Those skilled in the art will recognize that the logical presentation of steps is sufficiently instructive to carry out aspects of the claimed subject matter irrespective of any particular development language in which the logical instructions/steps are encoded.

Of course, while these routines include various novel features of the disclosed subject matter, other steps (not listed) may also be carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 6 below. Additionally, in various embodiments all or some of the various routines may also be embodied in executable hardware modules including, but not limited to, system on chips (SoC's), codecs, specially designed processors and or logic circuits, and the like on a computer system.

As suggested above, these routines/processes are typically embodied within executable code modules comprising routines, functions, looping structures, selectors such as if-then and if-then-else statements, assignments, arithmetic computations, and the like. However, as suggested above, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer-executable instructions stored by computer-readable media, also referred to as computer-readable storage media, which are articles of manufacture. As those skilled in the art will recognize, computer-readable media can host, store and/or reproduce computer-executable instructions and data for later retrieval and/or execution. When the computer-executable instructions that are hosted or stored on the computer-readable storage devices are executed by a processor of a computing device, the execution thereof causes, configures and/or adapts the executing computing device to carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer-readable media may reproduce and/or cause to deliver the computer-executable instructions and data to a computing device for execution by one or more processor via various transmission means and mediums including carrier waves and/or propagated signals, for purposes of this disclosure computer readable media expressly excludes carrier waves and/or propagated signals.

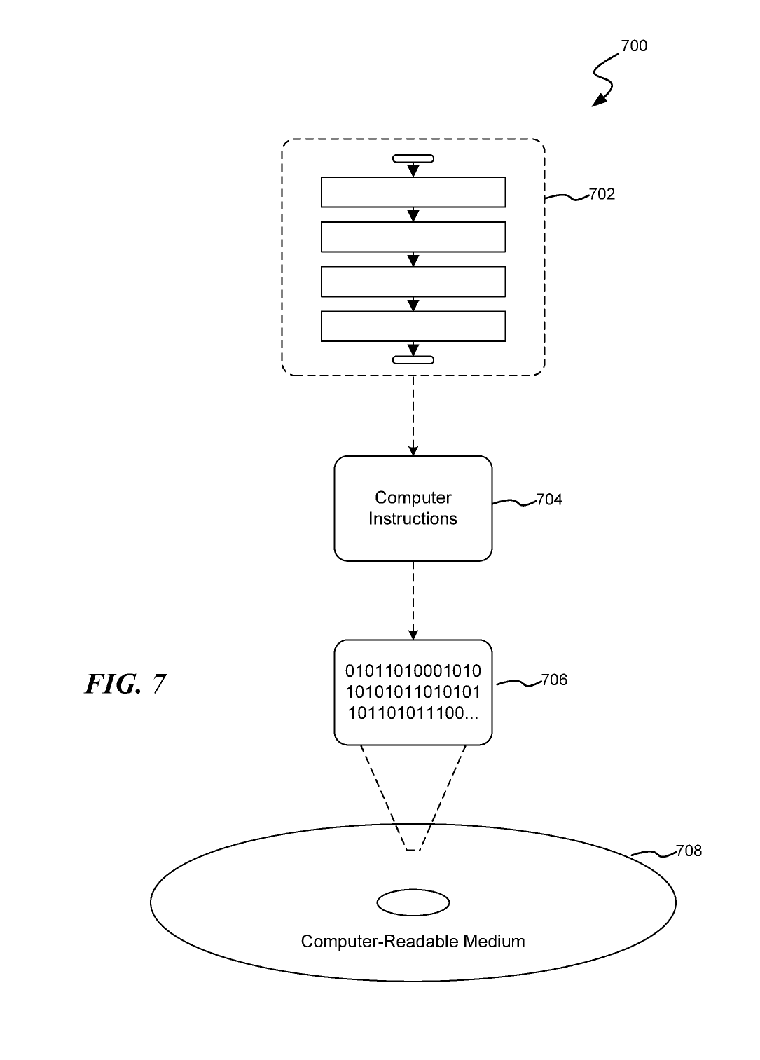

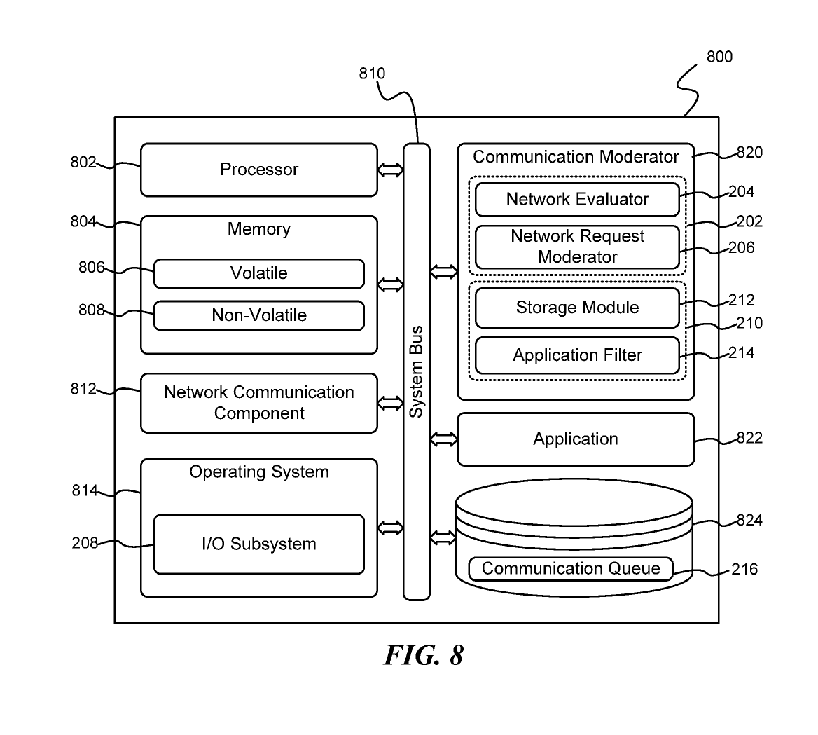

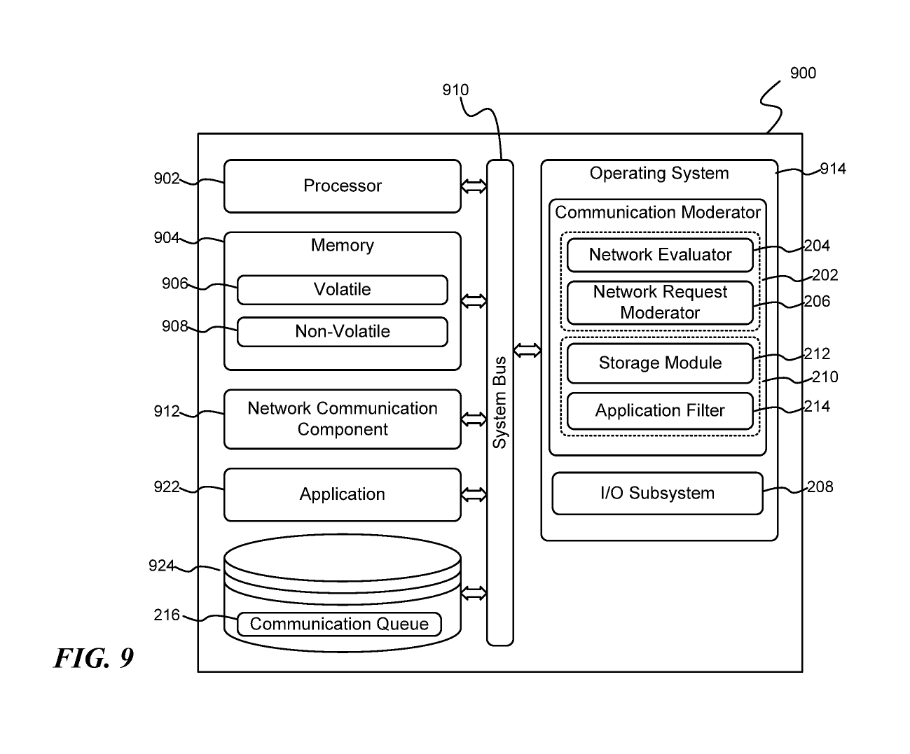

Turning to FIG. 7, FIG. 7 is a block diagram illustrating an exemplary computer readable medium encoded with instructions to configure/operate network communication quality according to aspects of the disclosed subject matter. More particularly, the implementation 700 comprises a computer-readable medium 708 (e.g., a CD-R, DVD-R or a platter of a hard disk drive), on which is encoded computer-readable data 606. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary methods 300 to 600 of FIGS. 3 through 6 respectively, for example. In another such embodiment, the processor-executable instructions 704 may be configured to implement a system, such as at least some of the exemplary computing systems 800 or 900 of FIGS. 8 and 9, as described below. Many such computer-readable media may be devised by those of ordinary skill in the art that are configured to operate in accordance with the techniques presented herein.

Turning now to FIG. 8, FIG. 8 is block diagram illustrating an exemplary computing device 800 suitably configured to moderate network communications of an app or application according to current network connectivity quality in accordance with aspects of the disclosed subject matter. The exemplary computing device 800 includes one or more processors (or processing units), such as processor 802, and a memory 804. The processor 802 and memory 804, as well as other components, are interconnected by way of a system bus 810. The memory 804 typically (but not always) comprises both volatile memory 806 and non-volatile memory 808. Volatile memory 806 retains or stores information so long as the memory is supplied with power. In contrast, non-volatile memory 808 is capable of storing (or persisting) information even when a power supply is not available. Generally speaking, RAM and CPU cache memory are examples of volatile memory 806 whereas ROM, solid-state memory devices, memory storage devices, and/or memory cards are examples of non-volatile memory 808.

The processor 802 executes instructions retrieved from the memory 804 (and/or from computer-readable media, such as computer-readable media 700 of FIG. 7) in carrying out various functions of a search engine configured to diversity search results as described above. The processor 802 may be comprised of any of a number of available processors such as single-processor, multi-processor, single-core units, and multi-core units.

Further still, the illustrated computing device 800 includes a network communication component 812 for interconnecting this computing device with other devices and/or services over a computer network 108, including other computing devices, such as network computing devices 110 and 112 of FIG. 1. The network communication component 812, sometimes referred to as a network interface card or NIC, communicates over a network (such as network 108) using one or more communication protocols via a physical/tangible (e.g., wired, optical, etc.) connection, a wireless connection, or both. As will be readily appreciated by those skilled in the art, a network communication component, such as network communication component 812, is typically comprised of hardware and/or firmware components (and may also include or comprise executable software components) that transmit and receive digital and/or analog signals over a transmission medium (i.e., the network.)

The computing device 800 further includes an operating system 814 that includes an I/O subsystem 208. As will be appreciated, an I/O subsystem 208 comprises a set of hardware, software, and/or firmware components that enable or facilitate inter-communication between a user of the computing device 800 and the processing system of the computing device 800 as well as between the computing device and external services, resources, and/or computers over a network 108.

The computing device 800 also includes a communication moderator 820. The communication moderator includes all of the functionality for moderating network requests commensurate with current network communication quality. Indeed, the communication moderator 820 includes moderation module 202 that includes, as sub-components, a network evaluator 204 and network request moderator 206 as described above in regard to FIG. 2. Also included in the communication moderator 820 is a network request monitor 210. As described above, the network request monitor 210 includes a storage module 212 and an application filter 214 as described above in regard to FIG. 2.

The computing device 800 still further includes at least one executable application (or app) that is suitably configured to provide the functionality to the communication moderator 820 to moderate network request activity according to network connectivity quality. Further, a data store 824 stores the communication queue for one or more apps and/or applications, including application 822.

Turning now to FIG. 9, FIG. 9 is block diagram illustrating an alternative exemplary computing device 900 suitably configured to moderate network communications of an app or application according to current network connectivity quality in accordance with aspects of the disclosed subject matter. In similarity to computing device 800, exemplary computing device 900 includes one or more processors (or processing units), such as processor 902, and a memory 904. The processor 902 and memory 904, as well as other components, are interconnected by way of a system bus 910. The memory 904 typically (but not always) comprises both volatile memory 906 and non-volatile memory 908.

The processor 902 executes instructions retrieved from the memory 904 (and/or from computer-readable media, such as computer-readable media 700 of FIG. 7) in carrying out various functions of a search engine configured to diversity search results as described above. The processor 902 may be comprised of any of a number of available processors such as single-processor, multi-processor, single-core units, and multi-core units.

Further still, the illustrated computing device 900 includes a network communication component 912 for interconnecting this computing device with other devices and/or services over a computer network 108, including other computing devices, such as network computing devices 110 and 112 of FIG. 1.

The computing device 900 further includes an operating system 914 that includes an I/O subsystem 208. As will be appreciated, an I/O subsystem 208 comprises a set of hardware, software, and/or firmware components that enable or facilitate inter-communication between a user of the computing device 900 and the processing system of the computing device 800 as well as between the computing device and external services, resources, and/or computers over a network 108.

In addition to the I/O subsystem 208 and according to alternative aspects of the disclosed subject matter, the operating system 914 also includes a communication moderator 920. As described above, the communication moderator 820 includes/provides all of the functionality for moderating network requests commensurate with current network communication quality as discussed above, but in this alternative embodiment the communication moderator is hosted as part of the operating system 914. Moreover, while apps and/or applications may advantageously benefit from the communication moderation 920 (or 820), so too may the operating system be advantaged through moderation of communication activity based on network quality. Further still, while not shown, the communication moderation service may also be implemented as a third-party service external to the exemplary computing devices.

As with the communication moderator 820 of FIG. 8, the communication moderator 920 includes a moderation module 202 that includes, as sub-components, a network evaluator 204 and network request moderator 206 as described above in regard to FIG. 2. Also included in the communication moderator 920 is a network request monitor 210. As described above in regard to FIG. 2, the network request monitor 210 includes a storage module 212 and an application filter 214.

Also shown as included in the exemplary, alternative computing device 900 is at least one executable application 922 (or app) that is suitably configured to provide the functionality to the communication moderator 820 to moderate network request activity according to network connectivity quality. Further, a data store 924 stores the communication queue for one or more apps and/or applications, including application 922

Regarding the various components of the exemplary user computing devices 800 and 900, those skilled in the art will appreciate that these components may be implemented as executable software modules stored in the memory of the computing device, as hardware modules and/or components (including SoCs—system on a chip), or a combination of the two. Indeed, as indicated above, components such as the communication monitor 820 or 920 may be implemented according to various executable embodiments including executable software modules that carry out one or more logical elements of the processes described in this document, or as a hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions described herein.

Moreover, in certain embodiments each of the various components of the user computing devices 800 and 900 may be implemented as an independent, cooperative process or device, operating in conjunction with or on one or more computer systems and or computing devices. It should be further appreciated, of course, that the various components described above should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computing device may be combined together or distributed across multiple actual components and/or implemented as cooperative processes on a computer network, such as network 108 of FIG. 1.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for moderating the network connectivity of an application with regard to network connectivity quality, the method comprising:
maintaining a communication queue of most recent network request data of a moderated application on a computing device;
determining a current network connectivity quality for the moderated application according to the network request data of the moderated application maintained in the communication queue; and
issuing a moderation instruction to the moderated application corresponding to the determined current network connectivity quality for the moderated application;
wherein the moderation instruction corresponds to a directive to the moderated application to alter network request activity from a first level of functionality to a second level of functionality.

2. The computer-implemented method of claim 1 further comprising:
repeatedly receiving network request data of recent network requests of the moderated application;
updating the communication queue according to the received network request data;
determining an updated current network connectivity quality according to the most recent network request data for the moderated application in the communication queue; and
issuing a subsequent moderation instruction to the moderated application corresponding to the determined updated current network connectivity quality for the application if the updated current network connectivity quality has changed from a previous current network connectivity quality.

3. The computer-implemented method of claim 2, wherein the most recent network request data in the communication queue comprises network request tuples, each network request tuple corresponding to a recent network request of the moderated application.

4. The computer-implemented method of claim 3, wherein repeatedly receiving network request data of recent network requests of the moderated application comprises:
repeatedly receiving network request data, the network request data comprising a plurality of network requests carried out on the computing device by any one or more of a plurality of applications executing on the computing device;
filtering the network request data according to whether or not a network request of the network request corresponded to the moderated application, wherein filtering a network request removes those network requests that are not originated from the moderated application from use by the method on behalf of the moderated application; and
for each network request of the filtered network request data:
generating a network request tuple according to the network request; and
storing the network request tuple in the most recent network request data corresponding to the moderated application in the communication queue.

5. The computer-implemented method of claim 3, wherein determining the updated current network connectivity quality for the moderated application comprises determining the updated current network connectivity quality for the moderated application according to one or more heuristics or a predetermined threshold according to the network request data in the communication queue.

6. The computer-implemented method of claim 3, wherein the most recent network request data in the communication queue comprises network request tuples, each network request tuple corresponding to a recent network request of the moderated application.

7. The computer-implemented method of claim 1 further comprising:
receiving a network change notice, the network change notice corresponding to a change in a network channel by which the computing device communicates; and
resetting the communication queue for the moderated application.

8. The computer-implemented method of claim 1, wherein issuing the moderation instruction to the moderated application comprises issuing the moderation instruction to the moderated application via an application programming interface (API) implemented by the moderated application.

9. The computer-implemented method of claim 1, wherein issuing the moderation instruction to the moderated application comprises issuing the moderation instruction to the moderated application via a call-back function of the moderated application.

10. The computer-implemented method of claim 1, wherein the moderation instruction identifies the determined current network connectivity quality for the moderated application as one of a high or a low quality.

11. The computer-implemented method of claim 1, wherein the moderation instruction identifies the determined current network connectivity quality for the moderated application as one of a high, a medium, or a low quality.

12. The computer-implemented method of claim 1, wherein the moderation instruction identifies the determined current network connectivity quality for the moderated application as a percentage value between a highest connectivity quality and a lowest connectivity quality.

13. A computer-readable medium bearing computer-executable instructions which, when executed on a computing device comprising at least a processor executing instructions retrieved from the medium, carry out a method for moderating the network connectivity of a moderated application with regard to network connectivity quality, the method comprising:
maintaining a communication queue of most recent network request data of a moderated application on a computing device, wherein the most recent network request data in the communication queue comprises network request tuples, each network request tuple corresponding to a recent network request of the moderated application;
determining a current network connectivity quality for the moderated application according to the communication queue; and
issuing a moderation instruction to the moderated application corresponding to the determined current network connectivity quality for the moderated application;
wherein the moderation instruction corresponds to a directive to the moderated application to alter network request activity from a first level of functionality to a second level of functionality.

14. The computer-readable medium of claim 13, wherein the method further comprises:
repeatedly receiving network request data of recent network requests of the moderated application;
updating the communication queue according to the received network request data;
determining an updated current network connectivity quality according to the most recent network request data for the moderated application in the communication queue; and
issuing a subsequent moderation instruction to the moderated application corresponding to the determined updated current network connectivity quality for the application if the updated current network connectivity quality has changed from a previous current network connectivity quality.

15. The computer-readable medium of claim 14, wherein repeatedly receiving network request data of recent network requests of the moderated application comprises:
repeatedly receiving network request data, the network request data comprising a plurality of network requests carried out on the computing device by any one or more of a plurality of applications executing on the computing device;
filtering the network request data according to whether or not a network request of the network request corresponded to the moderated application, wherein filtering a network request removes those network requests that are not originated from the moderated application from use by the method on behalf of the moderated application; and
for each network request of the filtered network request data:
generating a network request tuple according to the network request; and
storing the network request tuple in the most recent network request data corresponding to the moderated application in the communication queue.

16. The computer-readable medium of claim 14, wherein determining the updated current network connectivity quality for the moderated application comprises determining the updated current network connectivity quality for the moderated application according to one or more heuristics or a predetermined threshold according to the network request data in the communication queue.

17. The computer-readable medium of claim 14, wherein the most recent network request data in the communication queue comprises network request tuples, each network request tuple corresponding to a recent network request of the moderated application.

18. The computer-readable medium of claim 13, wherein the method further comprises:
receiving a network change notice, the network change notice corresponding to a change in a network channel by which the computing device communicates; and
resetting the communication queue for the moderated application.

19. A computing device configured to moderate the network connectivity of a moderated application with regard to network connectivity quality, the computing device comprising a processor and a memory, wherein the processor executes instructions stored in the memory and causes the computing device to:
maintain a communication queue of most recent network request data of the moderated application;
determine a current network connectivity quality for the moderated application according to the most recent network request data of the moderated application in the communication queue; and
issue a moderation instruction to the moderated application corresponding to the determined current network connectivity quality for the moderated application;
wherein the moderation instruction corresponds to a directive to the moderated application to alter its network request activity from a first level of functionality to a second level of functionality.

20. The computing device of claim 19, wherein maintaining the communication queue of most recent network request data of the moderated application, determining the current network connectivity quality for the moderated application, and issuing the moderation instruction to the moderated application are implemented on the computing device as part of the operating system of the computing device.
